(19) United States
(12) Patent Application Publication
(10) Pub. No.: US 2010/0282099 A1
(43) Pub. Date: Nov. 11, 2010

(54) Magnetic Homogenizer Apparatus

(76) Inventors: Lahav Gil, Toronto (CA); Rade Gadzic, Toronto (CA); Igal Roytblat, Richmond Hill (CA)

Correspondence Address: MARSHALL & MELHORN, LLC, FOUR SEAGATE - EIGHTH FLOOR, TOLEDO, OH, 43604, US

(21) Appl. No.: 12/437,810

(22) Filed: May 8, 2009

(51) Int. Cl. B30B 1/42; B30B 9/00

(52) U.S. Cl. 100/39; 100/98 R; 100/299; 100/214

(57) ABSTRACT

A homogenizer apparatus and method for homogenizing are provided for breaking up a solid sample in a container. The container has an impactor freely movable therein. The impactor has a magnetic field associated therewith. The homogenizer apparatus includes a magnetic field generator which produces an alternating magnetic field and a container holder adapted to maintain the container in a position in which it is subjected to the alternating magnetic field of the magnetic field generator. The alternating magnetic field causes movement of the impactor within the container to repeatedly force the impactor against the sample.

### FIELD OF THE INVENTION

The present invention relates to homogenizers and, more particularly, to methods and systems for breaking up a solid sample into smaller particles.

### BACKGROUND OF THE INVENTION

The extraction of compounds from solids, such as food, soil, drug tablets or animal tissue requires homogenization of the sample. Homogenization is the process of breaking down a solid sample into smaller particles.

Various equipment has been used to homogenize samples. One type of equipment, which has commonly used to homogenize relatively soft animal and plant tissue samples, essentially consists of a motor driven bladed impeller held within a tube. Another type of equipment, which may be used for processing relatively hard samples, consists of beads that are vibrated within a container.

Traditionally, homogenization is a slow process since it typically requires homogenization of a sample using a homogenizer shaft, followed by thorough cleaning of the homogenizer shaft in order to minimize cross-contamination between samples. Shaft and impeller type homogenizers are particularly difficult to clean as membranous materials become entangled in the homogenizer. These remnants must be completely removed prior to processing additional samples and this cleaning process is difficult and time consuming and sometimes ineffective.

Additionally, different sample types often require substantially differing equipment to process effectively. Hard samples, such as nuts and coffee beans cannot typically be processed in homogenizers used for soft tissue samples.

Accordingly, there exists a need for improved homogenizer methods and apparatuses.

### SUMMARY OF THE INVENTION

In one aspect, the present application describes a homogenizer apparatus for breaking up a solid sample in a container. The container has an impactor freely movable therein. The impactor has a magnetic field associated therewith. The homogenizer apparatus includes a magnetic field generator which produces an alternating magnetic field. The homogenizer apparatus further includes a container holder adapted to maintain the container in a position in which it is subjected to the alternating magnetic field of the magnetic field generator. The alternating magnetic field causes movement of the Impactor within the container.

In another aspect, the present application provides a method of homogenizing a solid sample. The method comprises: a) placing the solid sample in a container; b) placing an impactor in the container, the impactor having a magnetic field associated therewith; and c) applying an alternating magnetic field to the container to induce movement of the impactor and repeatedly force the impactor against the solid sample.

The ability to separate the vessel and impactor from the apparatus allows for easy cleaning and ready adaptability to a wide variety of sample types.

Other aspects and features of the present application will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present application, and in which:

FIG. 1 shows a perspective view of an example of the homogenizer apparatus in accordance with an embodiment of the present disclosure;

FIG. 2 shows a front view of the homogenizer apparatus of FIG. 1;

FIG. 3 shows a top plan view of the homogenizer apparatus of FIG. 1;

FIG. 4 shows a container for user with the homogenizer apparatus of FIG. 1;

FIG. 5 is a flowchart illustrating an example method of homogenizing a solid sample in accordance with an embodiment of the present disclosure;

FIG. 6 shows a perspective view of a dumbbell shaped impactor for use in the homogenizing apparatus of FIG. 1 in accordance with an embodiment of the present disclosure;

FIG. 7 shows a perspective view of an impactor having protrusions in accordance with an embodiment of the present disclosure;

FIG. 8 shows a perspective view of an impactor having a magnet embedded in a non-magnetic material in accordance with an embodiment of the present disclosure;

FIG. 9 shows a perspective view of an impactor having a magnet embedded in a non-magnetic material in accordance with a further embodiment of the present disclosure;

FIG. 10 shows a perspective view of an impactor having a plurality of magnets in accordance with an embodiment of the present disclosure;

FIG. 11 shows a front view of a container for use with the homogenizer apparatus of FIG. 1 in accordance with some embodiments of the present disclosure;

FIG. 12 is a flowchart illustrating an example method of homogenizing a solid sample in accordance with an embodiment of the present disclosure;

FIG. 13 is a front plan view of a homogenizer apparatus in accordance with one example embodiment of the present disclosure; and

FIG. 14 is a cross sectional side view of the homogenizer apparatus of FIG. 13 taken along the lines of 1-1 of FIG. 13.

Similar reference numerals are used in different figures to denote similar components.

### DESCRIPTION OF SPECIFIC EMBODIMENTS

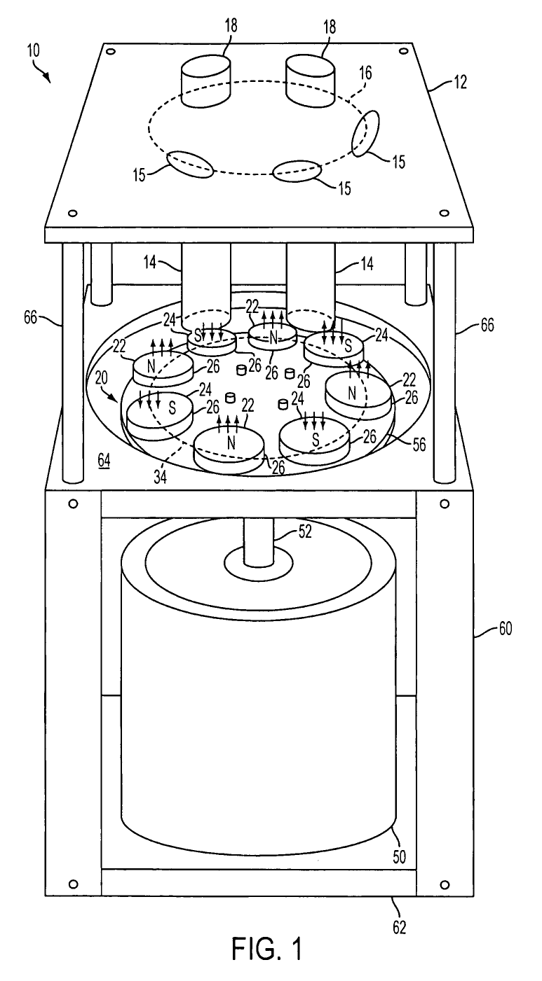

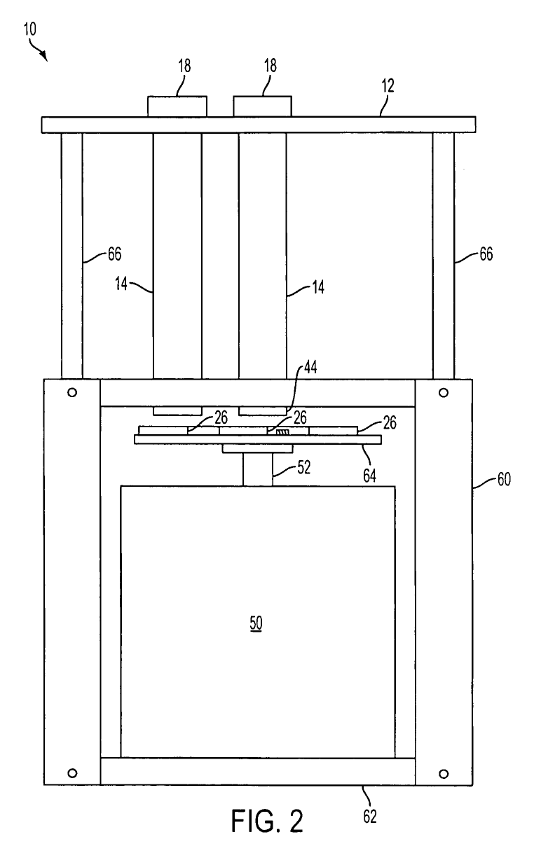

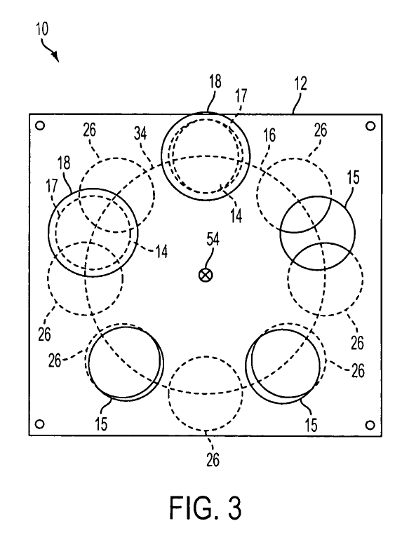

Reference is first made to FIGS. 1 to 3, which show a homogenizer apparatus 10 for breaking up a solid sample. FIG. 1 shows a perspective view of the homogenizer apparatus 10; FIG. 2 shows a front view of the homogenizer apparatus 10; and FIG. 3 shows a top plan view of the homogenizer apparatus 10. The homogenizing apparatus 10 may be used for homogenizing a solid sample. Homogenizing is the process of breaking down the solid sample into smaller particles. The homogenizing apparatus 10, homogenizes a sample by repeatedly causing an object to impact the solid sample. This impact may result in shredding, smashing or grinding of the solid sample, which causes the sample to be broken down into smaller particles.

The homogenizer apparatus 10 includes a container holder 12 which is adapted to receive and support at least one container 14. The container holder 12 is constructed of a non-magnetic material, or a material having very weak magnetic properties. The container holder 12 may be configured to receive more than one container 14; for example, in the embodiment of FIGS. 1 to 3, the container holder 12 is adapted to receive five containers 14. Where the container holder 12 is configured to receive a plurality of containers 14, the containers 14 may be arranged in a circular array 16. This arrangement permits bulk homogenizing. That is, it permits multiple solid samples 42 located in multiple containers 14 to be homogenized at the same time. The containers 14 may be uniformly distributed along the circular array 16.

The containers 14 may be held in place in the container holder 12 using a variety of mechanisms. For example, in some embodiments, the container holder 12 has one or more passages therethrough, such as one or more holes 15. The holes 15 are of a size sufficient to permit the passage of the container 14, but, in at least some embodiments, not large enough to permit a closure 18, such as a container lid, which is larger in cross section than the container 14, to pass. It will be appreciated by one skilled in the art that other means for removably attaching the containers 14 to the container holder 12 are also possible. For example, in some embodiments (not shown), the container holder 12 may include one or more clamp for clamping the containers 14 to the container holder 12.

The homogenizer apparatus 10 also includes a magnetic field generator, indicated generally by reference numeral 20, which applies an alternating magnetic field to the container 14. As will be explained in greater detail below, the magnetic field is used to move a magnetic impactor 40 within the container 14 in order to repeatedly force the impactor 40 against a solid sample 42. The repetitive impact of the impactor 40 against solid sample 42 breaks the solid sample into smaller particles.

The magnetic field generator 20 creates an alternating magnetic field which acts upon the container 14. In the embodiment shown, the magnetic field generator 20 is located vertically beneath the container holder 12 and the container 14. The alternating magnetic field which is applied to the container 14 by the magnetic field generator 20 includes periods in which the magnetic field applied to the container 14 is in a first direction 22 and periods in which the magnetic field is in a second direction 24. The first direction 22 is generally parallel to and in the opposite direction of the second direction 24.

In some embodiments, the alternating magnetic field is created using two or more generating magnets 26. Each generating magnet 26 is movable between a position in which it is near the container 14 and a position in which it is away from the container 14. When the generating magnet 26 is in a first position in which it is near the container 14, the magnetic field generated by that generating magnet 26 acts upon the container 14. When the generating magnet 26 is in the second position, in which it is located away from the container 14, the magnetic field from the generating magnet 26 does not operate on that container 14. In the example illustrated in FIGS. 1 to 3, the generating magnet 26 is in the first position when it is immediately beneath the container 14. In this position, the magnetic field created by that generating magnet 26 is applied to a bottom surface 44 (FIG. 2) of the container 14.

Between the first and second positions, there may be periods in which the magnetic field from the generating magnet 26 acts on the container 14, but to a lesser extent than when in the first position. That is, there may be periods between the first position and the second position in which the magnetic field from the generating magnet 26 is still applied to the container 14, but the magnetic field from the generating magnet 26 on the container 14 is weaker in this position than when the generating magnet 26 is directly beneath the container 14 in the first position.

As is common, the generating magnets 26 each have a south pole side 24 and a north pole side 22. In some embodiments, the size of each side is greater than or generally equal to the size of a cross-section of the container 14. That is, the south pole side 24 and the north pole side 22 of each generating magnet are, in some embodiments, sufficiently large that the magnetic field created by that generating magnet 26 is applied to the entire bottom surface 44 of the container 14 when that generating magnet 26 is directly beneath the container 14. This relationship permits the full force of the generating magnet 26 to be applied to the impactor 40.

In some embodiments, the generating magnets 26 are circular magnets. Similarly, in some embodiments, the container 14 may have a circular cross-section 17. In embodiments in which the cross section of the generating magnets 26 and the cross-section 17 of the container 14 are both circular, the diameter of the generating magnets 26 may be greater than or generally equal to the diameter of the container 14. As explained above, this relationship permits the full force of the generating magnet 26 to be applied to the impactor 40 when the generating magnet 26 is directly beneath the container 14. That is, when the generating magnet 26 is directly beneath the container 14, the impactor 40 cannot escape the magnetic field of the generating magnet 26.

In some embodiments, the generating magnets 26 are permanent magnets such as rare earth magnets. As will be appreciated by a person skilled in the art, rare earth magnets are strong magnets which are made from alloys of rare earth elements. Rare earth magnets may be desirable since they provide very strong magnetic fields. In some embodiments, the magnetic strength of the generating magnets 26 is, generally, thirty (30) pounds. All of the generating magnets 26 may have, generally, the same strength.

The generating magnets 26 may be arranged in a circular array 34. The generating magnets 26 may be evenly distributed along the circular array 34. That is, the space between adjacent generating magnets 26 is uniform across the array 34 of magnets 26.

In some embodiments, each of the generating magnets 26 has one of its poles 24, 22 near the container 14 relative to the other one of its poles 24, 22. That is, each generating magnet 26 has a pole which is exposed to the container 14 (this pole may be referred to as the container-side pole) and a pole 24, 22 which is not exposed to the container 14 (this pole may be referred to as the non-container-side pole). The pole 24, 22 which is relatively nearer the container 14 (i.e. the container-side pole), and which is exposed to the container 14, may also be referred to as the generating pole 24, 22 since this pole generates the magnetic field which the container 14 is exposed to.

The polarity of the generating pole 24, 22 for each magnet 26 in the circular array 34 may be opposite the polarity of the generating pole of adjacent magnets 26 to that magnet 26. That is, the polarity of the generating pole 24, 22 alternates between adjacent generating magnets 26 in the circular array 34. Generating magnets 26 having a north generating pole are adjacent to generating magnets 26 having a south generating pole. Similarly, generating magnets 26 having a south generating pole are adjacent to generating magnets 26 having a north generating pole.

The circular array 34 generally includes at least two generating magnets 26. It will be appreciated that the circular array 34 may include a greater number of magnets 26. For example, in some embodiments the circular array may include four magnets 26. In other embodiments, the circular array may include eight magnets. By using more than one magnet 26, when the magnets 26 are rotated about an axis 54 (FIG. 3), a magnetic field which frequently changes direction may be created and applied to the container 14. That is, the container 14 is alternatively exposed to magnetic fields created by south poles 24 and magnetic fields created by north poles 22. The frequency of the change may be large due to the use of multiple magnets 26.

It will be appreciated that in some embodiments fewer generating magnets 26 could be used in order to achieve the same effect. However, in such cases, it would be necessary to rotate the circular array 34 of magnets 26 at a greater rate in order to achieve the same rapidly changing magnetic field applied to the container 14. For example, in some embodiments, two magnets may be used.

The generating magnets 26 may include field directing elements or “keepers” to contain, refine, extend or intensify the magnetic field shape.

The magnetic field generator 20 also includes a motor 50 for rotating the generating magnets 26 between their first and second positions. That is, the motor 50 rotates the generating magnets 26 to positions in which they are near one of the containers 14 and positions in which they are away from that container 14.

The motor 50 rotates a shaft 52 about an axis 54. The shaft 52 is connected to a plate 56 upon which the generating magnets 26 are mounted. Accordingly, rotation of the shaft 52 creates rotation of the generating magnets 26. More particularly, the shaft 52 rotates each of the generating magnets 26 between their first position in which that generating magnet 26 is located near the container 14 and in which the magnetic field from the generating magnet 26 operates on the container, and their second position in which the generating magnet 26 is located away from the container 14 and in which the magnetic field from the generating magnet 26 does not operate on the container.

The motor 50 may be, for example, an electric motor, such as a direct current (DC) motor. In some embodiments, the motor may be configured to operate generally at a speed of approximately 1750 rotations per minute (RPM). However, it will be appreciated that the speed of the motor 50 may vary based on the diameter of the circular array 34 defined by the generating magnets 26, the type and quantity of the sample being homogenized, the number of generating magnets 26 in the array, and other factors. In some embodiments, the motor 50 may be a variable speed motor, allowing an operator, or an electronic controller, to configure the speed based on any one or more of these factors.

The shaft 52 of the motor 50 and the circular array 34 of generating magnets 26 each rotate about the same axis 54 (FIG. 3). The circular array 16 of containers 14 may also have a center point aligned with the axis 54 of rotation of the shaft 52.

In some embodiments, the circular array 34 of generating magnets 26 may be aligned with the circular array 16 of containers 14. The containers 14 may be held in a position immediately above the generating magnets 26 in the circular array 34. That is, the container holder is positioned to hold the containers 14 generally along the circle defined by the array 34 of generating magnets 26. The circular array 34 formed by the generating magnets 26 may have the same, or generally the same, radius and center as the circular array 16 formed by the containers 14.

The container holder 12 is connected to the motor 50 through a frame 60. The frame 60 may include a motor support 62 which is connected to the motor 50. The frame may also include a guard 64 for inhibiting access to the rotating portions of the apparatus 10. In the embodiment shown, the guard is a plate having a large hole therethrough, which permits the containers 14 to be exposed to the generating magnets 26. The guard is generally constructed of a non-metallic and non-ferromagnetic material such as, for example, plastic.

The frame 60 may also include a housing (not shown) for covering the motor 50 and further inhibiting access to the motor 50 and shaft 52.

In some embodiments, the frame 60 is connected to be container holder 12 via one or more adjustable support 66. The adjustable support 66 permits the container holder 12 to be raised or lowered to accommodate larger or smaller containers. That is, the adjustable support 66 permits the container holder 12 to be vertically movable relative to the generating magnets 26. In other embodiments (not shown), the container holder 12 is fixed and the generating magnets 26 are movable relative to the fixed container holder 12. In such embodiments, an adjustable support which supports the generating magnets 26 may provide for such movement.

In yet further embodiments, neither the container holder 12 nor the generating magnets 26 are vertically movable relative to one another. To ensure that the containers 14 are appropriately spaced from the generating magnets 26, the homogenizer apparatus 10 may be designed for use with a container 14 of a predetermined size. In either case, the container holder 12 and frame 60 are designed to support the container 14 in a position in which the bottom surface 44 of the container 14 is in close proximity to magnets 26. In some embodiments, the proximity of the container 14 to the magnet 26 is generally in the range of one to two millimeters (1 to 2 mm). That is, the distance of separation between the bottom surface 44 of the container 14 and the top of the generating magnet 26 when the generating magnet 26 is located directly beneath the container 14 is generally in the range of one to two millimeters. It will be appreciated, however, that other ranges may also work, and that the optimal range will depend, at least in part, on the size and strength of the generating magnets 26 and the impactor 40.

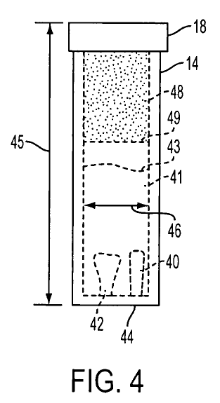

Referring now to FIG. 4, a container 14 for use with the homogenizer apparatus of FIGS. 1 to 3 is illustrated. In the embodiment shown in FIG. 4, the container 14 is a cylindrical container having a flat bottom. That is, the container 14 has a flat internal bottom surface inside the container 14 and a flat external bottom surface 44 outside of the container 14. The use of a flat bottom may, in some embodiments, provide for an area of contact with the magnetic field from the generating magnets 26 which is greater than the area of contact if non-flat bottom containers 14 were used.

The container 14 is typically constructed of a non-ferromagnetic material which is resistant to chemical degradation and solvents and which does not break, or otherwise fail, easily. By way of example and not limitation, the container 14 may be constructed of ceramics, aluminum, stainless steel, polyethylene, polypropylene, or fluorinated polymers. The container 14 may be internally and, in some embodiments, externally coated with a chemical-resistant coating. In some embodiments, the container 14 may be constructed of a material having hydrophobic properties in order to prevent the adhesion of water molecules to the container 14 and improve efficiency when transferring the sample from the container 14 to another container or vessel and to enhance the ability to readily clean the container 14 should reuse be desired. In other embodiments, the container 14 may be internally coated with a hydrophobic coating.

As will be explained more fully below, a solid sample 42 may be placed in the container 14 together with the impactor 40. The solid sample 42 may be a sample of a variety of different sample types. By way of example and not limitation, the solid sample 42 may be a sample of animal tissue, such as liver or brain, human tissue, rodent palleted diets, a plant sample such as a sample from a fibrous plant such as celery or carrots. In some applications, the sample 42 may be coffee beans and the homogenizer apparatus 10 may be used to grind the coffee beans.

The impactor 40 has a magnetic field associated therewith. The impactor 40 may include at least one permanent magnet, such as a rare earth magnet, such as a neodymium magnet. In some embodiments, the impactor 40 may be a single elongate rectangular magnet.

Every dimension of the impactor 40 is less than an internal diameter 46 of the container 14. That is, where the impactor 14 is rectangular, its width, length, and height are all smaller than the internal diameter 46 or cross section 17 of the container 14. Accordingly, the impactor 40 is able to move freely within the container 14. More particularly, the impactor 40 is sized to permit it to move horizontally and vertically within the container and to be able to rotate freely within the container 14. That is, the impactor 40 is able to rotate vertically within the container 14. This free rotation allows the impactor 40 to move generally chaotically when the magnetic field, generator 20 applies the alternating magnetic field to the bottom surface 44 of the container 14.

The movement of the impactor 40, under the force of the magnetic field created by the alternating magnetic field generator 20 is constrained only by the sides and bottom 44 of the container 14 and the sample 42 itself, which may impede movement of the impactor 40, at least until the sample 42 is broken down.

In some embodiments, the impactor 40 is of essentially smooth external construction to facilitate cleaning.

A closure 18 may hermetically seal the container 14. The closure 18 may be removably fastened to the container 14. For example, the closure 18 may matingly engage the container 14 through the use of threaded connectors. That is, the closure 18 may be a screw cap. In other embodiments, the closure 18 may be a friction cap which frictionally engages the container 14.

In some embodiments, the closure 18 may be hingedly connected to the container 14. In other embodiments, the closure 18 may be wholly separable from the container 14.

As discussed above, in some embodiments, such as the embodiment of FIG. 1, the diameter of the closure 18 may be greater than the diameter of the container 14 to permit the container 14, to permit the container holder 12 to engage the closure 18 but not the container 14. In the example of FIG. 4, the closure 18 is illustrated as being oriented on a top portion of the container 14. However, in other embodiments, the closure 18 may be located on the bottom or side of the container 14.

In some embodiments, a plug 48 may be used to further restrict movement of the impactor 40 within the container 14. The plug 48 may be placed within the container 14, at the top of the container 14. In some embodiments, the plug 48 may be permanently affixed to the closure 18. In other embodiments, the plug 48 may be physically separate from the closure 18.

The plug 48 may be constructed of a variety of materials. In some embodiments, it may be constructed of a deformable material which permits the plug 48 to be securely fitted within the container 14. For example, in some embodiments the plug 48 is constructed of cork. In other embodiments, the plug 48 may be a rubber stopper. The use of an elastic material such as cork or rubber or polymeric elastomer may also permit much of the energy of the impactor 40 to be conserved when the impactor 40 strikes the plug 48. It will, however, be appreciated that the plug 48 may be constructed of other materials.

The plug 48 may extend into the container 14 to a position in which the bottom side 49 of the plug 48 impedes the path of the impactor 40 when it is moved by the external magnetic field. More particularly, a bottom side 49 of the plug 48 is oriented above the sample 42 in the container 14.

In some embodiments, in order to facilitate the homogenization process, a solvent 41 may be added to the container 14 prior to homogenization. The solvent 41 may be an organic solvent, a reagent or water. The solvent may also facilitate the homogenization of the sample, including the shredding, smashing, or grinding process. The solvent 41 may do so by rupturing the cell membrane of the sample 42 so that the content of the cells are released and extracted into the solvent 41.

In embodiments in which a solvent 41 is used, the bottom side 49 of the plug 48 may be placed in close proximity to a fill level 43 of the solvent 41. In some embodiments, the distance between the bottom side 49 of the plug and the fill level 43 of the solvent is generally 2 millimeters (2 mm). This distance may be referred to as the headspace.

In embodiments in which a plug 48 is not used, the container 14 may be sized so that a height 45 of the container 14 allows the closure 18 to impede the path of the impactor 40 when it is moved by the external magnetic field. Where a solvent 41 is used, the bottom of the closure 18 may be in close proximity to the fill level 43 of the solvent. In other embodiments, where a plug 48 is not used, the fill level 43 of the solvent may be in close proximity to the closure 18. That is, the headspace between the fill level 43 of the solvent and the bottom of the closure may be small. In some embodiments, the headspace between the fill level 43 of the solvent and the bottom of the closure 18 may be generally two millimeters (2 mm).

Alternative embodiments and applications may, however, use different headspace distances than those discussed above. For example, in some embodiments, there is a larger separation between the fill level 43 of the solvent 41 and the plug 48 or the closure 18 to permit a gas or vacuum to be introduced into the container 14 which may aid in the homogenization process.

Referring again to FIG. 1, in some embodiments, the motor 50 may be connected to a timing device (not shown). The timing device may monitor the length of time during which the sample 42 has been processed by the homogenizer apparatus 10. The timing device may report the time duration to a user of the homogenizer apparatus 10. For example, the timing device may include a display screen, such as a liquid crystal display, for reporting the processing time duration to the user. In some embodiments, the timing device may be configured to terminate the homogenizing process after a specified period of time. The homogenizing process may be terminated by stopping the motor 50; for example, by powering down the motor 50. The specified period of time after which the process is terminated may be specified by the user or it may be predetermined; for example, by the manufacturer of the homogenizer apparatus 10. In some embodiments, the predetermined period of time may be 30 seconds.

The timing device may also include a controller for controlling the rotational speed of the motor 50 during various times in the process. The controller may be configured to vary the speed of the motor during processing. That is, during processing the controller may be configured to cause the motor 50 to operate at a first speed for a predetermined period of time and then operate at a second speed that is different than the first speed for an additional predetermined period of time.

The homogenizer apparatus 10 may be used to break-up a solid sample into smaller particles. The movement of the shaft 52 of the motor 50 about the axis 54 causes the generating magnets 26 to rotate about the axis 54. The movement of the generating magnets 26 creates an alternating magnetic field under each of the containers 14. The alternating magnetic field includes periods where the magnetic field applied to one of the containers 14 is directed upwardly, towards the container 14, and includes periods where the magnetic field applied to that same container 14 is directed downwardly, into the generating magnet 26. The alternating magnetic field creates movement of the impactor 40 within the container 14. The impactor 40 moves chaotically in the container 14, bouncing off of the container 14 and repeatedly smashing, grinding, or otherwise impacting the sample 42. This repetitive impact causes the sample 42 to break down into smaller particles.

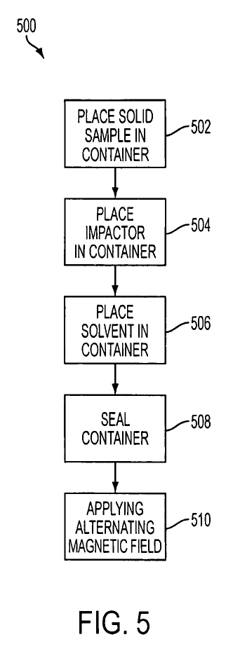

An overview having been provided, reference will now be made to FIG. 5 which is a flowchart illustrating a process 500 for homogenizing a solid sample 42. The method 500 may be performed using a homogenizer apparatuses 10 according to one of the embodiments described herein and the method 500 may include any methods of using the homogenizer apparatus 10 described in the present disclosure for the purpose of breaking down a solid sample 42 into smaller particles.

At step 502, the solid sample 42 is placed in the container 14. The size or mass of the sample 42 may vary between applications.

The solid sample may be, for example, human or animal tissue. Next, at step 504, the impactor 40 is placed in the container 14 with the solid sample 42. In some embodiments, at step 506, a solvent 41 may be added to the container 14. The solvent may be added until a fill level 43 is reached. The fill level 43 may be in close proximity to the closure 18 or the bottom side 49 of the plug 48. In some embodiments, the solvent 41 may be water.

It will be appreciated that steps 502, 504 and 506 may be performed in any order. That is, the impactor 40, solid sample 42 and solvent 41 may be placed in the container 14 in any order.

At step 508, the container 14 is closed. The container 14 may be closed by placing the plug 48 in the container 14 and attaching the closure 18 to the container to seal the container 14. In some embodiments, the plug 48 is inserted so that the bottom side 49 of the plug 48 is near the fill level 43 of the solvent. The plug 48 creates an upward barrier which impedes the movement of the impactor.

In other embodiments, a plug 48 may not be used. In such embodiments, the container 14 may be closed by fastening the closure 18 to the container 14.

Next, at step 510 an alternating magnetic field is applied to the container 14 using the magnetic field generator 20. The alternating magnetic field may be applied to the container 14 at the bottom surface 44 of the container 14. The alternating magnetic field which is applied to the container 14 includes periods in which the magnetic field applied to the container 14 is in a first direction and periods in which the magnetic field applied to the container 14 is in a second direction, which is opposite to the first direction. That is, it includes periods in which a south pole 24 is placed in close proximity to the container 14 and other periods in which a north pole 22 is placed in close proximity to the container 14.

At step 510, the alternating magnetic field induces movement of the impactor 40 within the container 14. The movement of the impactor 40 within the container 14 repeatedly forces the impactor against the solid sample 42. This repeated action causes the solid sample 42 to break down into smaller particles. The alternating magnetic field may move the impactor 40 in directions which include both horizontal and vertical movement. The impactor 40 may also be vertically rotated within the container 14.

The magnetic field may be applied to the container 14 at step 510 for a period of time which is sufficient to break down the solid sample into sufficiently small particles. For example, in some embodiments, the alternating magnetic field may be applied for approximately 30 seconds. In some embodiments, the processing time may be controlled by a timing device. In such embodiments, the process 500 may also include a step of setting a processing time on the timing device. When the alternating magnetic field has been applied to the container 14 for the specified period of time, the magnetic field generator 20 may be turned off.

In some embodiments, as described above, the alternating magnetic field may be created by repeatedly moving two or more generating magnets 26 between a first position in which that generating magnet 26 is located near the container 14 and in which the magnetic field from that generating magnet 26 operates on the container 14 and a second position in which that generating magnet 26 is located away from the container 14 and the magnetic field from that generating magnet 14 does not operate on the container 14.

Each generating magnet 26 has a south pole side 24 and a north pole side 22. As explained previously, each generating magnet 26 may have one of its poles 22, 24 exposed to the container 14.

In some embodiments, the size of each pole is greater than or equal to the size of a cross section 17 of the container 14.

Having provided a number of example embodiments, the following description will now discuss some additional example embodiments in accordance with further aspects of the present disclosure.

It will be appreciated that, while the magnetic field generator 20 has been described above in an embodiment in which permanent magnets are used as generating magnets 26, in some embodiments an electric coil may be used to create an electromagnet which creates an alternating magnetic field having similar properties to the magnetic field created by the magnetic field generator 20 described above with reference to FIGS. 1 to 3. For example, an alternating magnetic field may be created by moving the electromagnet or by alternating the polarity of the electromagnet.

It will be appreciated that the use of permanent magnets, such as those discussed above in relation to FIGS. 1 to 3, has advantages of reduced complexity and energy consumption, but that the use of an electromagnet to generate an alternating magnetic field has the advantage of achieving an alternating magnetic field without, necessarily, requiring relative motion between the generating magnets 26 and the impactor 40. That is, the electromagnet can change from applying a magnetic field in one direction to applying a magnetic field in the opposite direction, without the need to physically rotate the magnet. Also, the use of an electromagnet allows for rapid changes in the frequency of the alternating magnetic field.

In some embodiments, one electromagnet may be disposed beneath the container 14 and another disposed at the side of the container 14. The arrangement would enable alternate or coincident fields from multiple directions which may, in some embodiments, increase the level of chaotic motion of the impactor 40 in the container 14.

Also, while FIGS. 1 to 3 illustrate an embodiment in which the motor 50 is connected to the circular array 34 of generating magnets 26 and the generating magnets 26 rotate relative to one or more fixed containers 14, in other embodiments (not shown), the motor 50 may be connected to the container holder 12 and the container 12 holder may move relative to fixed generating magnets 26. In such embodiments, the homogenizer apparatus 10 may also be used as a centrifuge. To act as a centrifuge, the homogenizer apparatus 10 may be configured to rotate the containers 14 at relatively high speeds in order to separate elements. In order to facilitate centrifugal separation, the containers 14 may be connected to the container holder using a lockable hinge (not shown). The hinges may be unlocked when using the centrifuge feature of the homogenizer apparatus 10 so that the containers 14 are free to pivot. That is, under centrifugal force, the hinge permits the bottom 44 (FIG. 4) of the containers 14 to travel outwardly away from the axis 54 of rotation and permits the top of the containers 14 to travel inwardly towards the axis 54 of rotation.

Thus, in at least some embodiments, the homogenizer apparatus 10 has at least two modes: homogenization; and centrifuge. The centrifuge mode may operate at higher speeds than the homogenization mode. That is, the containers 14 may be rotated at greater speeds in the centrifuge mode than in the homogenization mode. In some embodiments, the lockable hinge may lock the containers 14 in place during the homogenization mode so that the containers 14 are not permitted to rotate. In the centrifuge mode, the lockable hinge may be released, permitting the containers to pivot.

It will be appreciated, however, that the embodiment discussed above in relation to FIGS. 1 to 3 in which the containers 14 are fixed may be advantageous in at least some applications. For example, where the containers are fixed during homogenization, they are not subject to centrifugal force which may cause the impactor 40 and sample 42 to move to one side of the container 14.

Furthermore, while the containers 14 and generating magnets 26 of FIGS. 1 to 3 were illustrated as being uniformly distributed along circular arrays 16, 34, other arrangements are also contemplated. For example, the containers 14 and/or the generating magnets 26 may arranged in a non-uniform distribution along the circular array so that the spacing between adjacent containers 14 or magnets 26 varies. In some embodiments, non-circular distributions of the containers 14 and/or the generating magnets 26 may also be used.

Furthermore, while the discussion with respect to FIGS. 1 to 3 generally referred to embodiments in which the generating magnets 26 were located beneath the container 14, in at least some embodiments (not shown), one or more generating magnets 26 may be placed laterally along the side of one or more of the containers 14. For example, an L-shaped bracket could connected at one end to the plate 56 (FIG. 1) and at the other end to the generating magnet 26. In this way, the generating magnet 26 could be disposed along the side of one or more of the containers 14. The generating magnets 26 may also be oriented at other angles relative to the plate 56 and/or containers 14.

Furthermore, while the container 14 was illustrated in the embodiment of FIG. 4 as being a flat-bottomed container 14, in other embodiments, the container 14 may have a non-flat bottom. For example, in some embodiments, the bottom of the container 14 may be rounded, conical or hemispherical. Furthermore, in some embodiments, the container 14 may be non-cylindrical.

In some embodiments (not shown) the homogenizer apparatus 10 may include a temperature control system such as a heater or a cooler for controlling the temperature of at least one container 14. By way of example and not limitation, the heater may be an infrared source heater, a forced air convective heater, a resistive heater, or a water jacketed heater. By way of example and not limitation, where the temperature control system includes a cooler, the cooler may provide for active cooling; for example, with a forced air cooling system, or passive cooling; for example, using a heatsink.

Furthermore, while the impactor 40 in the embodiments discussed above in relation to FIGS. 1 to 4 was, generally illustrated as being rectangular in shape, it will be appreciated that other shapes and orientations are also contemplated. For example, the impactor 40 may, in some embodiments, be one of an ovoid solid, a sphere, a flattened sphere, a cylinder, or a flattened cylinder. Other shapes are also possible.

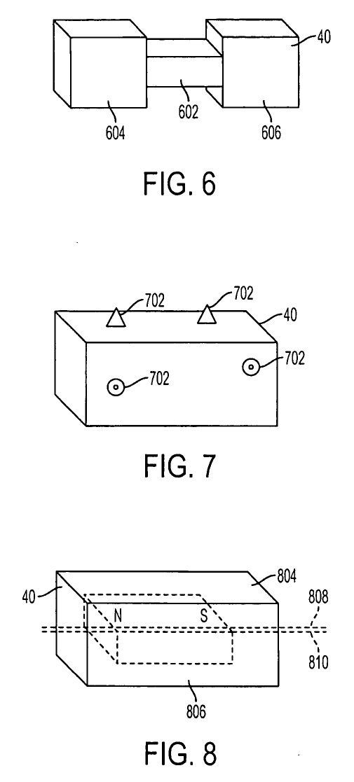

Referring, now to FIG. 6, the impactor 40 may, in some embodiments, be comprised of a plurality of ordinary shapes connected together to form a non-ordinary shape. For example, the impactor 40 may be comprised of a slender linkage 602 connecting expanded first 604 and second 606 ends, creating a dumbbell-shaped impactor 40. The first 604 and second 606 ends are wider than the linkage 602. The linkage 602 may be, for example, an elongate rectangular prism or it may be cylindrical.

The first 604 and second 606 ends may be comprised of a variety of shapes including, for example, spheres and rectangular prisms. In some embodiments, the first end 604 is of the same shape and size as the second end 606. In other embodiments, the first end 604 and the second end 606 are comprised of different shapes. The use of expanded ends 604, 606 may be used to concentrate the mass of the impactor 40 near its ends 604, 606. In some embodiments, the ends 604, 606 may be of different masses, creating a mass imbalance.

Referring now to FIG. 7, in some embodiments, the impactor 40 may include one or more protrusions 702 to facilitate breakdown of the sample 42. The protrusions 702 may be of various shapes, including, for example, conical, cylindrical, or rectangular.

In some embodiments, the Impactor 40 may have one or more edges which are blunt, sharpened or scalloped to facilitate processing of different sample types. For example, an impactor 40 without sharpened edged may be used to break down a relatively rigid or brittle sample where crushing of the sample may be used to break down the sample, and an impactor 40 having at least one sharpened edge may be used to break up a tissue sample. In the case of a tissue sample, the sharpened edge may create a cutting action which facilitates the breakdown of the sample.

The impactor 40 may, in some embodiments (not shown), contain features thereon for improving general fluid mixing. Such features may include, for example, flutes, spirals and vane type appendages. These features may be particularly useful in applications where higher shear rates are advantageous, particularly in applications where the sample 42 is relatively susceptible to initial gross disruption but requires breakdown of relatively soft disperse particulates.

In some embodiments, the impactor 40 may simply be a magnet, such as a bar magnet. Referring to FIG. 8, in other embodiments, the impactor 40 may be comprised of a non-magnetic material 804 which defines the shape of the impactor and which has embedded therein at least one magnet 806. For example, an impactor may be fabricated by insert injection molding magnets within a polymeric shape of a desired exterior form. The exterior form may be, for example, any of the shapes discussed above; or any other shapes. In the example of FIG. 8, the impactor 40 is fabricated in the shape of a rectangular prism. The non-magnetic material 804 may be fabricated to contain one or more localized features. For example, the impactor may contain regions having the protrusions 702 of FIG. 7.

In some embodiments, at least a portion of the impactor 40 may be constructed of a non-magnetic material 804 which is deformable or flexible. That is, the material 804 may be a material which deforms under the influence of one or more of the following forces: impact forces due to impact of the impactor 40 with the container 14, fluid dynamic forces, and/or a magnetic field forces created by the magnetic field generator 20 (FIG. 1).

In the example of FIG. 8, the magnet 806 is generally oriented in parallel alignment with the overall shape of the impactor 40. That is, the magnet 806 is an elongate magnet having a center axis 808 running along the length of the magnet between north and south poles. The magnet's center axis 808 is parallel to a center axis 810 of the Impactor 40 which runs along the length of the elongate impactor 40.

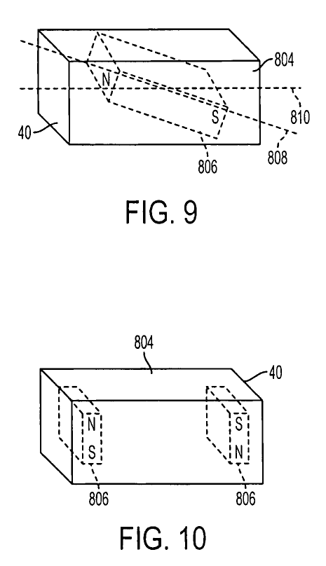

Referring to FIG. 9, in other embodiments, there is angular deviation between the magnet's center axis 808 and the center axis 810 of the impactor 40. That is, the center axis 808 of the magnet is not parallel to the center axis 810 of the impactor 40. In some embodiments, such angular deviation may be used in order to create a magnetic field imbalance within the impactor 40. This imbalance may increase the level of chaos in the motion of the impactor 40 when it is driven by the magnetic field generator 20.

Referring now to FIG. 10, in other embodiments the impactor 40 may contain a plurality of magnets 806. In the example shown, the impactor 40 contains two magnets 806. The plurality of magnets 806 creates a plurality of magnetic fields within the impactor 40. The plurality of magnetic fields may, in some embodiments, increase the level of chaos in the motion of the impactor 40 when it is driven by the magnetic field generator 20.

In some embodiments, the magnets 806 within the impactor 40 may be fitted with field directing elements or “keepers” (not shown). Such elements act to retain, refine, extend or intensify the specific magnetic field shape. In some embodiments, such elements may be used to shape or alter the interactions between the impactor and the magnetic field created by the magnetic field generator 20 (FIG. 1).

The impactor 40 may be coated with a coating which alters the mechanical or chemical characteristics of the impactor 40 surface. For example, a coating may be applied to the impactor 40 to make the surface of the impactor 40 more abrasive or rough. In some embodiments, the impactor 40 may be coated with a hydrophobic coating.

By way of example and not limitation, the external surface 40 of the impactor may be coated or comprised of any one of the following: polypropylene, fluorinated polymers, polyethylene, epoxies, metallic platings of nickel or chromium, and polyurethanes.

In some embodiments, the impactor 40 may be coated with a chemically reactive component which participates in the preparation of the sample 42 either by direct action, enzymatic action or catalytic action. In other embodiments, in which the introduction of a chemically reactive component is either necessary or desirable in order to prepare the sample 42, the impactor 40 may not be coated with the chemically reactive coating. Instead, the chemically reactive component may be added to the container 14 prior to, during, or after homogenizing of the solid sample 42.

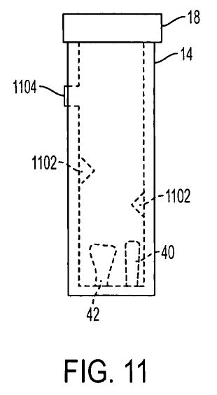

Furthermore, in various embodiments, the container 14 may have features in addition to or different from the features of the container 14 described previously with reference to FIG. 4. Referring to FIG. 11, in some embodiments, the container 14 may include one or more protrusions 1102 on the interior of the container 14. The protrusions 1102 may be located on the interior side walls of the container 14 or, in some embodiments (not shown), on the interior bottom surface of the container 14. In the example shown, the protrusions 1102 are conical in shape. In other embodiments, the protrusions 1102 may take other shapes including, for example, conical, hemispherical or rectangular. The protrusions 1102 may be used to grind, pierce or otherwise disturb the sample 42. In some embodiments, the protrusions 1102 may be used to increase the level of chaos in the motion of the impactor 40 within the container 14. For example, the impactor 40 may periodically strike the protrusions 1102 causing the impactor 40 to travel in a direction which is different than the direction in which the impactor 40 would have traveled if it had struck the interior walls of the container 14.

Referring still to FIG. 11, in some embodiments, the container 14 may include one or more ports 1104. The port 1104 may be used to add or remove solvents or reagents before, during or after homogenization of the sample 42. The port 1104 may also be used to control the flow of air into the container 14. For example, the port 1104 may be used to control the flow of inert air such as nitrogen into the container 14. This feature may be useful, for example, when the heat generated due to the force of friction between the impactor 40 and the container 14 or sample 42 is harmful to the compound being extracted. Such heat-sensitive samples may contain oxidizable compounds that are highly oxidizable by oxygen, such as proteins and usaturated fatty acids. Nitrogen may be introduced through the ports 1104 to replace the oxygen in the container 14 and minimize oxidation.

The ports 1104 may also, in some embodiments and applications, be used to remove air containing oxygen from the container 14 and create a vacuum. Creating a vacuum may be useful to minimize oxidation of samples containing oxidizable compounds.

The ports 1104 may also be used for some applications to add specific air mixtures at a desired pressure in order to facilitate chemical reactions within the container 14. For example, some reactions are known to be catalyzed under hypoxic conditions (95% carbon dioxide and 5% oxygen) or pressurized conditions.

It will be appreciated that the ports 1104 may be located in different locations than those discussed above. For example, in some embodiments (not shown), one or more ports may be disposed in the closure 18.

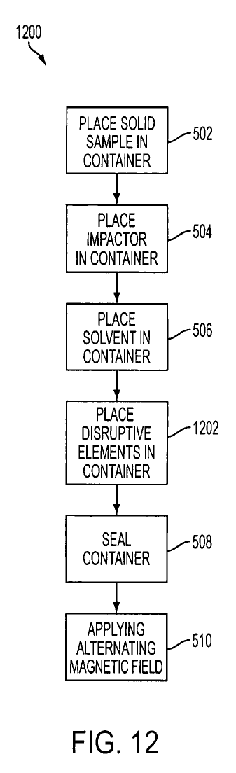

Referring now to FIG. 12, a homogenization process 1200 according to a further embodiment of the present disclosure will now be discussed. This embodiment includes all of the steps of the homogenization process discussed above with reference to FIG. 5, but includes an additional step 1202 wherein additional disruptive elements are introduced into the container 14. As with the process discussed in relation to FIG. 5, the sample 42 (step 502), impactor 40 (step 504) and solvent 41 (step 506) are all added to the container 14 before the container 14 is sealed (step 508) with the closure 18 and the alternating magnetic field is applied (step 510). However, in the process of FIG. 12, before the container 14 is sealed, additional disruptive elements are placed within the container 14. These disruptive elements may be non-magnetic and non-ferromagnetic disruptive elements which provide additional impact surfaces for interaction with the impactor 40. These elements may be movable due to fluid motions within the container 14. That is, where a solvent 41 is used in the homogenization process, the solvent 41 will be agitated by the movement of the impactor 40, creating fluid motions within the container 14. These fluid motions may impart kinetic energy to the disruptive elements causing the disruptive elements to move. These disruptive elements may contact the sample 42, thereby facilitating the breakdown of the sample 42.

The fluid motion of the solvent 41 or the impactor may also impart kinetic energy into the sample 42 itself, causing the sample 42 to move. The sample may move against the disruptive elements, further facilitating breakdown of the sample 42.

The disruptive elements may range from macro-structures which are comparable in size to the impactor 40 to granular structures which serve as grinding or abrasive elements.

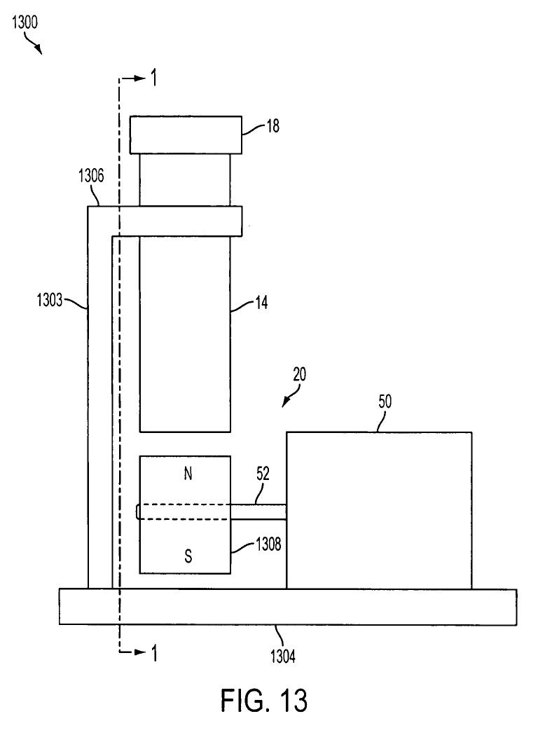

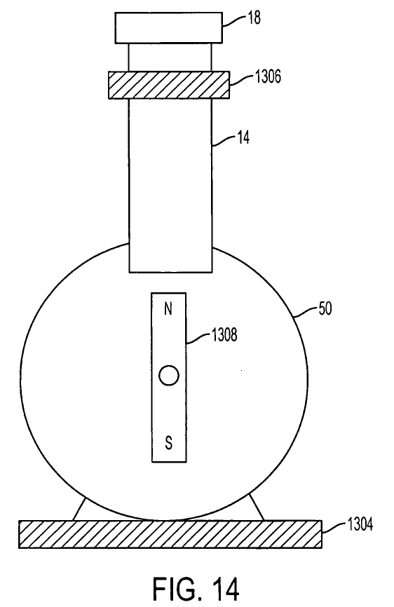

Referring now to FIGS. 13 and 14, a further embodiment of a homogenizer apparatus 1300 is shown. FIG. 13 illustrates a front view of the homogenizer apparatus 1300 and FIG. 14 illustrates a side view of the homogenizer apparatus 1300. In this embodiment, the container 14 remains fixed. A magnetic field generator 20 creates an alternating magnetic field which acts upon the container 14. The magnetic field generator 20 is comprised of a motor 50, a shaft 52 and at least one generating magnet 1308 which is connected to the shaft 52 and which is rotated by the motor 50.

The generating magnet 1308 has opposing poles which rotate about the shaft 52. Each pole rotates between a first position in which it is near the container 14 and in which the magnetic field created by that pole operates on the container 14 and a second position in which that pole is away from the container 14 and in which the magnetic field created by that pole does not operate on the container 14. For example, in the illustration of FIG. 13, the north, pole of the generating magnet 1308 is oriented in the first position in which it is near the container 14. In this position, the magnetic field 14 of the north pole is applied to the container 14. Similarly, in the example orientation of FIG. 13, the south pole of the generating magnet 1308 is oriented in the second position in which it is away from the container 14. In this position the magnetic field created by the south pole of the generating magnet 1308 is not applied to the container 14.

In the example shown, the generating magnet 1308 is a bar magnet having a hole bored therethrough which permits the shaft 52 of the motor 50 to be attached. The generating magnet has a first pole disposed on one side of the shaft 52 and a second pole of opposite polarity to the first pole, disposed on the opposite side of the shaft.

The shaft 52 extends horizontally from the motor, permitting the generating magnet 26 to rotate in a vertical plane.

The homogenizer apparatus 1300 of FIGS. 13 and 14 comprises a frame 1303 for holding the container 14 in spaced relation to the magnetic field generator 20. The frame 1303 may include a base 1304 and a container holder 1306. The frame 1303 may permit the container holder 1306 to be moved closed to or further from the magnetic field generator 20. That is, the frame 1303 may allow the distance between the container 14 and the magnetic field generator 20 to be varied.

The homogenizer apparatus 1300 may include additional elements not specifically shown in FIG. 13 or 14 including, for example, one or more guards which may inhibit user access to moving parts of the homogenizer apparatus 1300, or a timing device which may be used to provide for timed homogenization.

The container holder 1306 may be adapted to receive more than one container 14 to provide for bulk homogenizing of solid samples.

By way of example and not limitation, the solid sample 42 which may be homogenized using the homogenizer apparatus 10 may include tissue such as liver, shrimp (raw and/or cooked) and seeds such as nuts and coffee beans,

It will be appreciated that various combinations or minor modifications of the embodiments described above will yield greater efficiency in processing samples 42 of different types. For example, a flat-bottomed container 14 with a rectangular impactor 40 may efficiently homogenize cooked shrimp or liver, while a hemispherical bottomed container 14 with a spherical bead-type impactor 40 may efficiently grind coffee.

Certain adaptations and modifications of the invention will be obvious to those skilled in the art when considered in light of this description. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A homogenizer apparatus for breaking up a solid sample in a container, the container having an impactor freely movable therein, the impactor having a magnetic field associated therewith, the homogenizer apparatus comprising:
a magnetic field generator which produces an alternating magnetic field; and
a container holder adapted to maintain the container in a position in which at least a portion of the container is subjected to the alternating magnetic field of the magnetic field generator,
wherein the alternating magnetic field causes movement of the impactor within the container.

2. The homogenizer apparatus of claim 1, wherein the alternating magnetic field includes periods in which the magnetic field applied to the portion of the container is in a first direction and periods in which the magnetic field applied to the portion of the container is in a second direction, the second direction being opposite to the first direction.

3. The homogenizer apparatus of claim 1, wherein the portion of the container is an end of the container.

4. The homogenizer apparatus of claim 3, wherein the portion of the container is the bottom end of the container.

5. The homogenizer apparatus of claim 1, wherein the movement of the impactor includes horizontal and vertical movement of the impactor and vertical rotation of the impactor.

6. The homogenizer apparatus of claim 1, wherein the magnetic field generator comprises:
two or more generating magnets, each generating magnet movable between a first position in which that generating magnet is located near the container and in which the magnetic field from the generating magnet operates on the container, and a second position in which the generating magnet is located away from the container and the magnetic field from the generating magnet does not operate on the container.

7. The homogenizer apparatus of claim 6, wherein the generating magnets each have a south pole side and a north pole side and wherein the size of each of the sides is greater than or equal to the size of a cross section of the container.

8. The homogenizer apparatus of claim 6, wherein the magnetic field generator further comprises:
a motor connected to the generating magnets for moving the magnets between their first positions and second positions.

9. The homogenizer apparatus of claim 7, wherein the generating magnets are arranged in a circular array and wherein the container holder is positioned to hold the container along a circle defined by the array of generating magnets.

10. The homogenizer apparatus of claim 9 wherein the generating magnets in the circular array each have a side exposed to the container, and wherein the polarity of the exposed side alternates between adjacent generating magnets in the circular array.

11. The homogenizer apparatus of claim 9 wherein each of the generating magnets in the circular array are of generally equal strength.

12. The homogenizer apparatus of claim 1, wherein the generating magnets are rare earth magnets.

13. The homogenizer apparatus of claim 1 wherein the impactor is a rectangular magnet, every dimension of the impactors being less than an internal diameter of the container.

14. The homogenizer apparatus of claim 9 wherein there are four or more generating magnets in the circular array.

15. A method of homogenizing a solid sample, the method comprising:
placing the solid sample in a container;
placing an impactor in the container, the impactor having a magnetic field associated therewith;
applying an alternating magnetic field to at least a portion of the container to induce movement of the impactor and repeatedly force the impactor against the solid sample.

16. The method of claim 15 further comprising, prior to applying the magnetic field:
adding a solvent to the container.

17. The method of claim 16 further comprising, prior to applying the magnetic field:
placing a plug in the container near the solvent, wherein the plug creates a barrier which impedes the movement of the impactor.

18. The method of claim 15 wherein applying a magnetic field to the container includes:
alternatingly moving each of two or more generating magnets between a first position in which that generating magnet is located near the container and in which the magnetic field from the generating magnet operates on the container and a second position in which the generating magnet is located away from the container and the magnetic field from the generating magnet does not operate on the container.

19. The method of claim 15, wherein the portion of the container is an end of the container.

20. The method of claim 19, wherein the portion of the container is the bottom end of the container.

21. The method of claim 15, wherein the movement of the impactor includes horizontal and vertical movement of the impactor and vertical rotation of the impactor.

22. The method of claim 18, wherein the generating magnets each have a south pole side and a north pole side and wherein the size of each of the sides is greater than or equal to the size of a cross section of the container.

23. The method of claim 18, wherein every dimension of the impactor is less than an internal width of the container.

24. The method of claim 18, wherein the alternating magnetic field includes periods in which the magnetic field applied to the portion of the container is in a first direction and periods in which the magnetic field applied to the portion of the container is in a second direction, the second direction being opposite to the first direction.
